(19) United States
(12) Patent Application Publication
(10) Pub. No.: US 2008/0287292 A1
(43) Pub. Date: Nov. 20, 2008

(54) Illustrated card with paillettes

(76) Inventor: Teng-Kuei Chen, Taipei (TW)

Correspondence Address: Hershkovitz & Associates, LLC, 2845 Duke Street, Alexandria, VA, 22314, US

(21) Appl. No.: 11/798,568

(22) Filed: May 15, 2007

(51) Int. Cl. B41M 5/025

(52) U.S. Cl. 503/227

(57) ABSTRACT

An illustrated card has a cardboard, at least one printing layer and multiple paillettes. The cardboard has two surfaces. Each of the at least one printing layer is mounted on one of the surfaces of the cardboard and has a pattern ink layer and multiple adhesive spots. The pattern ink layer arranges a pattern and is mounted on the surface. The adhesive spots are attached to the pattern ink layer. The paillettes are mounted respectively on the adhesive spots. The illustrated card allows users especially children to make the illustrated card by themselves and children can be trained to arrange the pailletes with different colors to improve their sense of chromatology. Additionally, the users can mount directly the paillettes on the adhesive spots without contaminating their hands or clothes, so it is convenient for the users.

### BACKGROUND OF THE INVENTION

1. Field of Invention

The present invention relates to an illustrated card with paillettes, and more particularly to an illustrated card that can train children to arrange multiple colorful paillettes on the illustrated card to improve their sense of chromatology.

2. Description of the Related Art

An illustrated card can be used as a greeting card or a decoration on a wall. A conventional illustrated card has two surfaces. However, at least one surface has words or patterns, so users can not make and arrange the pattern or color on the surface by themselves. Thus, the conventional illustrated card is boring for users.

Additionally, children usually use color pens, watercolors, crayons or the like to daub. They usually fill colors on a coloring book that has a pattern contour on each page so that they can recognize and distinguish various colors and can applying tones. However, the coloring book can not be made to have a three-dimensional structure, so the coloring book can not attract children for a long time. Furthermore, children using color pens, watercolors, crayons or the like may contaminate their hands and clothes, which would annoy their parents.

To overcome the shortcomings, the present invention provides an illustrated card with paillettes to mitigate or obviate the aforementioned.

### SUMMARY OF THE INVENTION

The primary objective of the present invention is to provide an illustrated card that can train children to arrange multiple colorful paillettes on the illustrated card to improve their sense of chromatology.

To achieve the objective, the illustrated card in accordance with the present invention has a cardboard, at least one printing layer and multiple paillettes. The cardboard has two surfaces. Each of the at least one printing layer is mounted on one of the surfaces of the cardboard and has a pattern ink layer and multiple adhesive spots. The pattern ink layer arranges a pattern and is mounted on the surface. The adhesive spots are attached to the pattern ink layer. The paillettes are mounted respectively on the adhesive spots. The illustrated card allows users especially children to make the illustrated card by themselves and children can be trained to arrange the pailletes with different colors to improve their sense of chromatology. Additionally, the users can mount directly the paillettes on the adhesive spots without contaminating their hands or clothes, so it is convenient for the users.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an illustrated card with paillettes in accordance with the present invention;

FIG. 2 is an exploded cross sectional side view of a first embodiment of the illustrated card with paillettes in FIG. 1 with a release paper;

FIG. 3 is an exploded cross sectional side view of a second embodiment of the illustrated card with paillettes in FIG. 1;

FIG. 4 is an exploded cross sectional side view of a third embodiment of the illustrated card in FIG. 1;

FIG. 5 is a flow chart of a method to produce an illustrated card in accordance with the present invention;

FIG. 6 is a perspective view of a tool in accordance with the present invention for making an illustrated card with paillettes;

FIG. 7 is an exploded perspective view of the tool in FIG. 6;

FIG. 8 is a side view in partial section of the tool in FIG. 6 that shows an adhesive end is used to put a paillette on an illustrated card of the present invention; and

FIG. 9 is a perspective view of the tool in FIG. 6 that shows a blunt end is used to press a paillette toward an illustrated card of the present invention

### DETAILED DESCRIPTION OF THE INVENTION

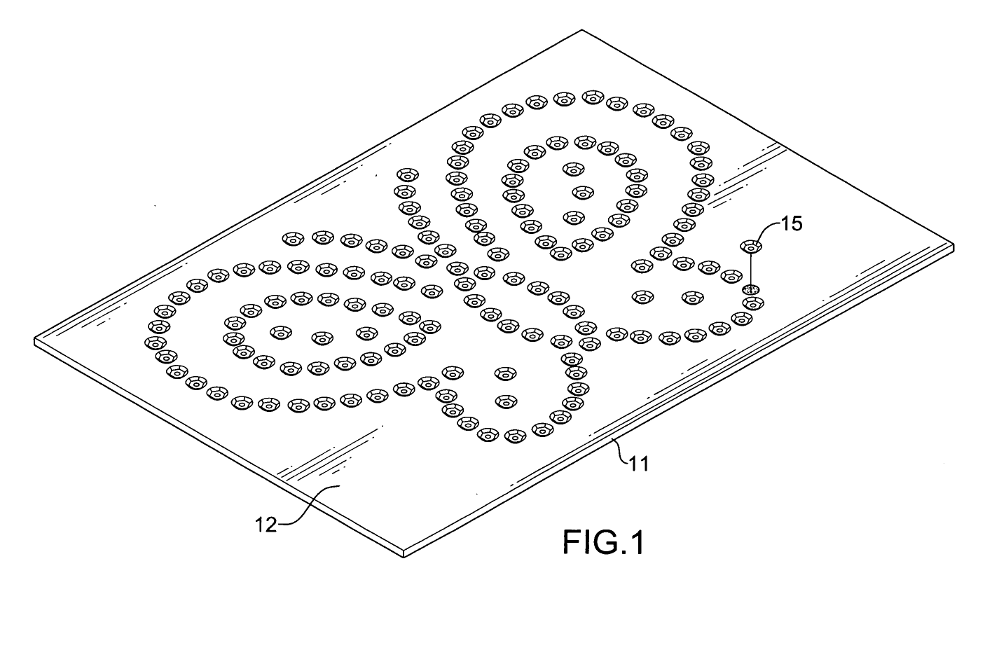

With reference to FIG. 1, an illustrated card in accordance with the present invention has a cardboard (11), at least one printing layer and multiple paillettes (15).

The cardboard (11) has two surfaces.

Each of the at least one printing layer is mounted on one of the surfaces of the cardboard (11) and has a pattern ink layer (12) and multiple adhesive spots (14).

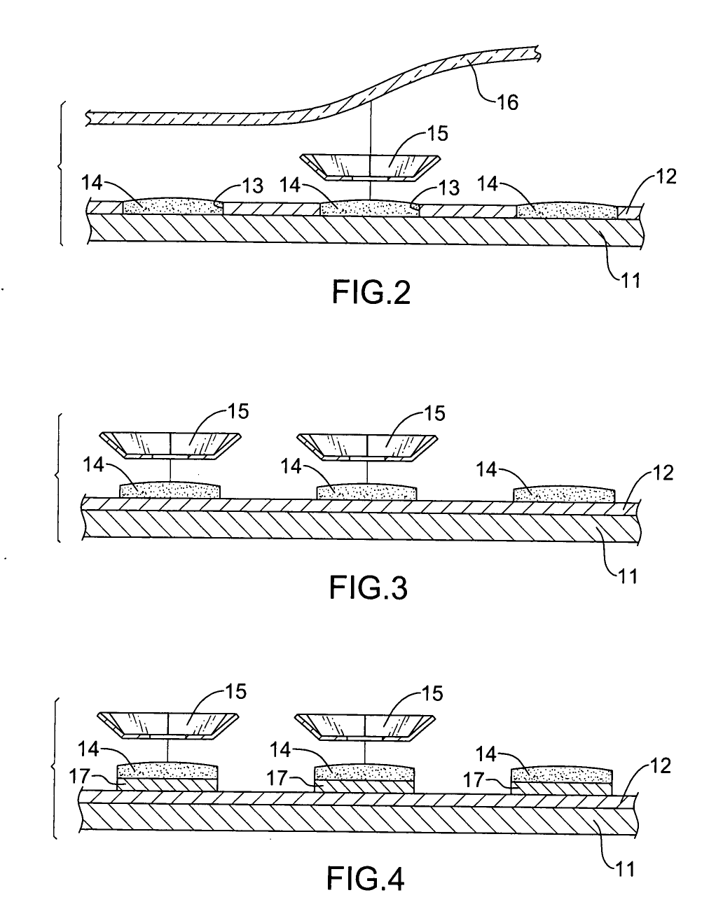

With further reference to FIGS. 2 and 4, the pattern ink layer (12) arranges a pattern and may be monochrome or polychrome. The pattern can be a completed figure such as characters, words, a human figure, an animal, a plant or the like or a part of the pattern such as a skirt or hair of the human figure or petals of the plant. The pattern ink layer (12) of a first embodiment of the illustrated card has multiple recesses (13). The recesses (13) are formed in the pattern ink layer (12) to arrange the pattern. The pattern ink layer (12) of a third embodiment of the illustrated card has multiple pigment spots (17). The pigment spots (17) are mounted on the pattern ink layer (12) to arrange the pattern.

With further reference to FIG. 3, the adhesive spots (14) are attached to the pattern ink layer (12), are mounted in the recesses (13) in the first embodiment of the illustrated card, are mounted directly on the pattern ink layer (12) to arrange the pattern in a second embodiment of the illustrated card or are mounted respectively on the pigment spots (17) in the third embodiment of the illustrated card.

The paillettes (15) are mounted respectively on the adhesive spots (14) and has various colors and shapes such as circular, star, flower or the like and may be flat or three-dimension.

Before the paillettes (15) are mounted on the adhesive spots (14), each of the printing layer can be covered by a release paper (16) as shown in FIG. 2.

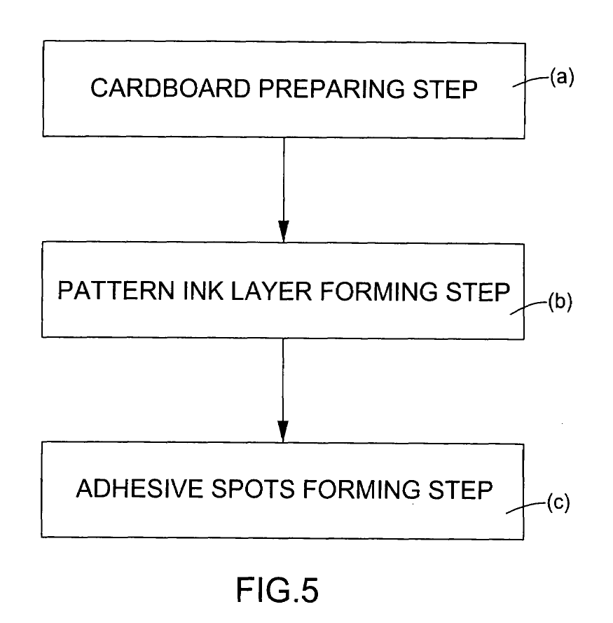

With further reference to FIG. 5, a method to produce the illustrated card in accordance with the present invention has a cardboard preparing step (a), a pattern ink layer forming step (b) and an adhesive spots forming step (c).

The cardboard preparing step (a) has preparing a cardboard (11).

The pattern ink layer forming step (b) has printing ink on at least one surface of the cardboard (11) to form a pattern ink layer (12). The ink covers a whole surface of the cardboard (11) when the second and the third embodiments of the illustrated card are produced. The ink covers part of the surface of the cardboard (11) to form multiple recesses (13) in the first embodiment of the illustrated card. The pattern ink layer (12) forming step (b) further has printing multiple pigments on the pattern ink layer (12) after printing the ink to form the pattern ink layer (12) with multiple pigment spots (17).

The adhesive spots forming step (c) has printing adhesives to form multiple adhesive spots (14) to the pattern ink layer (12) for receiving multiple paillettes (15). The adhesives are printed respectively in the recesses (13) when the first embodiment of the illustrated card is produced. The adhesives are printed directly on the pattern ink layer (12) when the second embodiment of the illustrated card is produced. The adhesives are printed respectively on the pigment spots (17) when the third embodiment of the illustrated card is produced.

The illustrated card allows users especially children to make the illustrated card by themselves and children can be trained to arrange the pailletes (15) with different colors to improve their sense of chromatology. Additionally, the users can mount directly the paillettes (15) on the adhesive spots (14) without contaminating their hands or clothes, so it is convenient for the users.

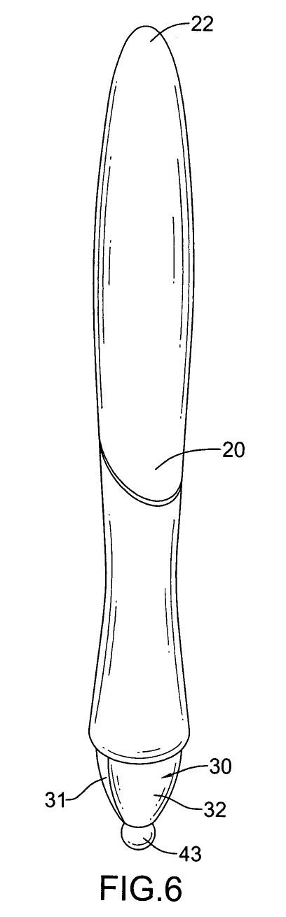

With further reference to FIG. 6, a tool in accordance with the present invention for making an illustrated card with paillettes has a body (20).

The body (20) is longitudinal and pen-like so users may hold the body (20) as simply as they hold a pen. The body (20) has an adhesive end and a blunt end (22).

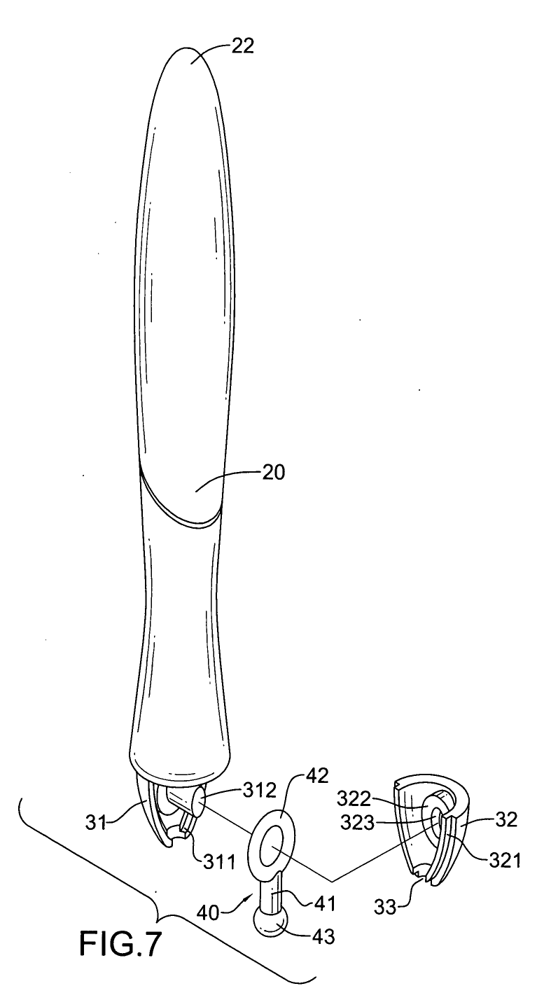

With further reference to FIG. 7, the adhesive end has a fastener (30) and an adhesive element (40).

The fastener (30) is conical, protrudes from the adhesive end of the body (20) and has an inner space, an enlarged end, a narrow end, a first half (31) and a second half (32).

The enlarged end is mounted on the adhesive end of the body (20).

The narrow end has a through hole (33). The through hole (33) is defined through the narrow end and communicates to the inner space of the fastener (30).

The first half (31) is formed integrally on the adhesive end of the body (20) and has an inner surface and two opposite side edges. The inner surface may have a protrusion (312) or a hollow protrusion. Each of the side edges has a first detent (311). The first detent (311) is formed in the side edge. The protrusion (312) protrudes from the inner surface. The hollow protrusion protrudes from the inner surface and has a mounting hole. The mounting hole is formed in the hollow protrusion.

The second half (32) is combined detachably with the first half (31) and has an inner surface and two opposite side edges. The inner surface may have a protrusion or a hollow protrusion (322). The protrusion protrudes from the inner surface. The hollow protrusion (322) protrudes from the inner surface has a mounting hole (323). The mounting hole (323) is formed in the hollow protrusion (322) and corresponds to the protrusion (312) of the first half (31) to receive the protrusion (312), so the first and second half (31, 32) are combined securely. Each of the sdie edges has a second detent (321). The second detent (321) is formed on the side edge and is mounted in one of the first detents (311) of the first half (31) to fasten the two halves (31, 32) firmly.

The adhesive element (40) is made of resin that has tiny stickiness such as thermoplastic resin (TPR) or silicone, is fastened by the fastener (30), is mounted in the inner space of the fastener (30) and protrudes from the through hole (33). The adhesive element (40) has a cylindrical segment (41), a fastening ring (42) and a sphere protrusion (43). The cylindrical segment (41) is mounted in the inner space of the fastener (30) and has a proximal end and a distal end. The fastening ring (42) is formed integrally from the proximal end of the cylindrical segment (41) and has a fastening hole. The fastening hole is mounted around the protrusion (312) of one of the first and second halves (31, 32) to fasten the adhesive element (40) to the fastener (30). The sphere protrusion (43) protrudes from the distal end of the cylindrical segment (41), is mounted out of the through hole (33) of the fastener (30) to adhere to the paillettes and may have various diameter corresponding to various dimension of the paillettes.

When users use the tool, they can use the sphere protrusion (43) to make the illustrated card by a method comprising an adhering step, a pressing step and a repeating step.

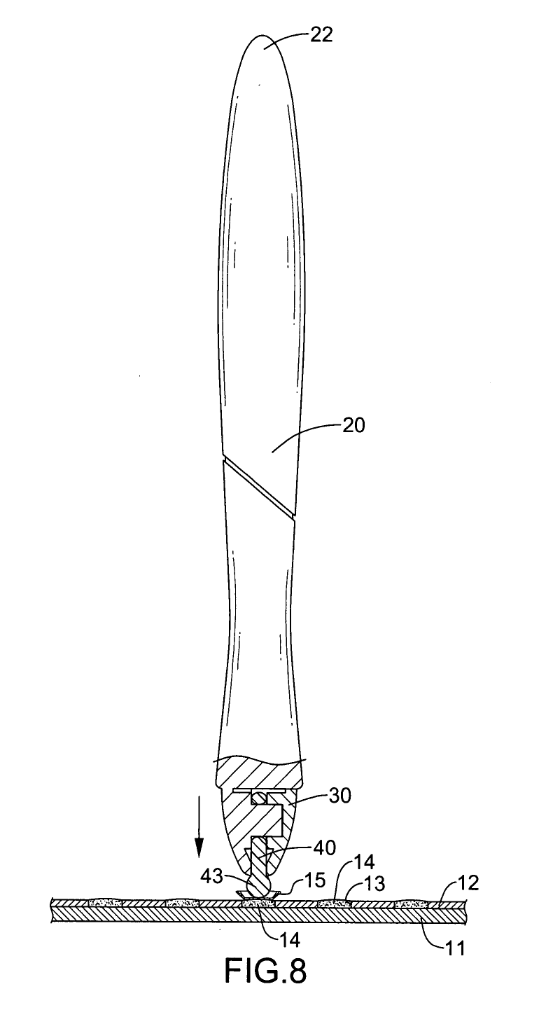

With further reference to FIG. 8, the adhering step comprises using the sphere protrusion (43) of the adhering element (40) of the tool to adhere one of the paillettes (15) and putting the paillette (15) on one of the adhesive spots (14). Because the adhesive spot (14) has a stronger stickiness than the adhering element (40) does, the paillette (15) will stay on the adhesive spot (14).

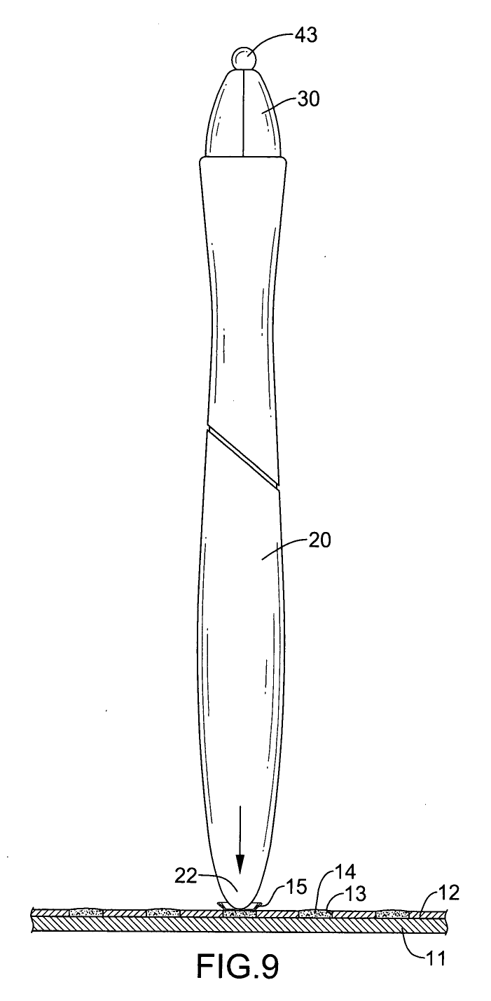

With further reference to FIG. 9, the pressing step comprises using the blunt end (22) to press the paillette (15) toward the adhesive spot (14), so the paillette (15) can adhere firmly to the illustrated card.

The repeating step comprises repeating the adhering step and the pressing step to allow all the adhesive spots (14) to adhere to the paillettes (15).

The paillettes (15) can be adhered more easily and rapidly by the adhesive element (40) than by a user's hand. Thus, using the tool of the present invention to make the illustrated card is convenient for the users.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An illustrated card comprising:
a cardboard having two surfaces;
at least one printing layer, and each one of the at least one printing layer mounted on one of the surfaces of the cardboard and having
a pattern ink layer arranging a pattern and mounted on a corresponding one of the surfaces; and
multiple adhesive spots attached to the pattern ink layer; and
multiple paillettes mounted respectively on the adhesive spots.

2. The illustrated card as claimed in claim 1, wherein
each one of the at least one pattern ink layer has multiple recesses formed in the pattern ink layer;
the adhesive spots are mounted respectively in the recesses of the at least one pattern ink layer.

3. The illustrated card as claimed in claim 1, wherein the adhesive spots is mounted directly on the at least one pattern ink layer.

4. The illustrated card as claimed in claim 1, wherein
the at least one pattern ink layer has multiple pigment spots mounted on the patter ink layer;
the adhesive spots are mounted respectively on the pigment spots of the at least one pattern ink layer.

5. The illustrated card as claimed in claim 1, wherein the paillettes are three-dimensional.
